(19) United States
(12) Patent Application Publication
(10) Pub. No.: US 2012/0049482 A1
(43) Pub. Date: Mar. 1, 2012

(54) FRONT END ASSEMBLY FOR A MOTOR VEHICLE COMPRISING A SUSPENSION WITH A TRANSVERSE BLADE

(75) Inventors: Arnaud Lizot, Asnieres-sur-Seine (FR); Bernard Niclot, Boulogne-Billancourt (FR)

(73) Assignee: PEUGEOT CITROEN AUTOMOBILES SA, Velizy Villacoublay (FR)

(21) Appl. No.: 13/264,609

(22) PCT Filed: Apr. 7, 2010
(86) PCT No.: PCT/FR2010/050669

§ 371 Date: Nov. 15, 2011

(30) Foreign Application Priority Data
Apr. 15, 2009 (FR) 0952457

(51) Int. Cl. B60G 11/08

(52) U.S. Cl. 280/124.171

(57) ABSTRACT

The invention relates to a front end assembly for a motor vehicle, in particular for motor vehicle, supporting each of the steering wheels (11) of the vehicle by means of a pivoting wheel holder (4), said front end assembly comprising a suspension comprising a transverse blade (1) made of composite material, attached to the body shell (5) of the vehicle and each end portion (2) of which is rigidly connected to the pivoting wheel holder (4), characterized in that each end (10) of the transverse blade (1) is suspended under the body shell (5) of the vehicle by a holder (6) sandwiching the end (10) of the blade (1), and in that a means (12; 17) for taking-up the longitudinal stresses to the brakes is arranged between the holder (6) of the blade (1) and the pivoting wheel holder (4); the end (10) of the blade (1), the holder (6) and the force take-up means (12; 17) substantially and respectively defining the three sides of a suspension triangle.

### CROSS-REFERENCE TO RELATED APPLICATIONS

This application is the US National Stage of International App. No. PCT/FR2010/050669, having an international filing date of Apr. 7, 2010, and which claims priority to French Pat. App. No. 09524457 which was filed on Apr. 15, 2009.

### BACKGROUND

The present invention relates to a front axle of an automotive vehicle comprising a transverse leaf suspension, also called integrated suspension, and to an automotive vehicle equipped with such a front axle.

Automotive vehicles in general have a directional front axle, mounted to the vehicle body, supporting the wheel hubs and ensuring at the same time that the wheels are guided, while allowing for displacement of the suspensions, and on the other hand, the rotation of the wheels when turning.

In the family of front axle architectures, the Pseudo Mac-Phearson (PMP) axle is the architecture offering the best price/performance compromise. That is why this technology is very wide spread among original equipment manufacturers.

This architecture comprises an element called a ‘strut’ consisting mainly of a shock absorber and a coil spring resting on the shock absorber body.

The strut controls the displacement in vertical direction of the wheel relative to the ground surface on which the vehicle runs as a function of a specific force/speed law.

The upper part of the strut is attached to the upper part of the vehicle body by means of joint allowing for rotation in vertical direction, while the lower part is attached to an element called a wheel ‘knuckle’ on which the wheel is mounted through the intermediary of wheel bearings.

The knuckle itself is connected to the body through the intermediary of a part made of a stamped plate, called a lower suspension arm.

The knuckle is mounted to the suspension arm by means of a pin allowing for the wheel to rotate with the knuckle during turns.

The suspension arm is attached to a lower part of the vehicle body called a “cradle” through the intermediary of two joints which are aligned in a longitudinal direction, parallel to the longitudinal direction of the vehicle. These two joints allow for a pivoting motion of the suspension arm during the vertical displacement of the wheel.

The front axle also comprises an anti-roll bar connecting the two wheels of the axle in order to compensate for, or to take up, the forces exercised independently on each of the wheels resulting in a torsional moment being applied to the front axle.

Finally, to control the turning of the wheel, a rack and pinion steering with an actuating arm connects the steering control device (steering wheel) to the wheel knuckle.

This architecture has evolved over time. The changes made allow for weight gain and compactness. The proposed changes involve replacing the suspension arms, the cradle, the springs and the anti-roll bar by a transverse leaf.

A first architecture is described in FR 2 503 054 A1. This document completely describes the design of a PMP axle with a transverse leaf. The leaf is attached to the body at two points ensuring the spring function of the anti-roll bar.

A second architecture, which is a development of the first, is described in WO 8301758 A1. This second architecture improves the transverse leaf concept by means of a leaf made of composite material consisting of unidirectional glass fibers and epoxide resin which is thicker at the extremities to compensate for the transverse and longitudinal forces to which the front axle wheels are subjected during braking and/or turning of the wheels.

According to a third architecture, described in EP 436 407 A1, the transverse leaf is attached to the vehicle body at four points, through the intermediary of vertically connecting arms. The leaf is Omega shaped to wrap around the powertrain.

### SUMMARY

The present invention proposes a new front axle architecture comprising a transverse leaf suspension in which the leaf is made preferably of a composite material and in which the function of taking up longitudinal forces due to braking is shifted away from the leaf.

In this way, thanks to this invention, it is possible to significantly reduce the volume of the composite leaf and therefore its cost. Taking into account the high cost of the material used for fabricating the leaf, the impact of the cost reduction of the leaf reflects upon the total price of the front axle architecture.

This advantage is added to the advantages of weight gain and compactness compared to a traditional PMP axle.

To this end, the invention relates to a front axle for a vehicle, in particular an automotive vehicle, which supports both directional wheels of the vehicle through the intermediary of a wheel knuckle support. The axle includes a suspension comprising a transverse leaf of composite material mounted to the body of the vehicle, whereby each extremity of the leaf is solidly connected to the wheel knuckle support, characterized in that each extremity of the transverse leaf is suspended under the vehicle body by means of a support which sandwiches the extremity of the leaf. Additionally, a means for taking up the longitudinal braking forces are arranged between the leaf support and the wheel knuckle support. The extremity of the transverse leaf, the support and the force take up means, respectively, define the three sides of a suspension arm.

According to one characteristic, the support is located on the leaf and extends transversely relative to the leaf in a direction parallel to the longitudinal axis of the vehicle. First and second fastening means are disposed respectively at the two extremities of the support through the intermediary of first and second elastic joints in order to mount the support to the body of the vehicle; while the first joint is adjacent to the transverse leaf.

According to another characteristic, the means for taking up the longitudinal forces during braking consist of a rectilinear arm to which the extremities are respectively attached via an elastic joint to the knuckle support, and to the second joint of the support.

According to a variant, the means for taking up the longitudinal forces during braking comprise the straight portion of a bent anti-roll bar extending parallel to the transverse leaf. The extremity of the straight portion of the bent anti-roll bar is attached to the wheel knuckle support by means of elastic mounting means and the extremity of the straight portion of the anti-roll bar, not bent, is attached to the support, in the proximity of the second joint, by means of an elastic knuckle linkage.

According to another characteristic, the leaf support is also used as a support for the steering rack. Means for mounting the rack on the support are arranged in the proximity of the second support joint.

According to another characteristic, each support is arranged between the extremity of the leaf and the longitudinal axis of the vehicle.

According to another characteristic, the longitudinal axis of the leaf is centered on the axis of the wheels.

The invention has also as a goal a front axle as described above.

### BRIEF DESCRIPTION OF THE SEVERAL VIEWS OF THE DRAWINGS

The invention will be better understood and other characteristics and advantages will become clear by reading the following description, provided as a non-limiting example, with reference to the attached drawings, in which:

FIGS. 1 and 2 illustrate schematic top and side views, respectively, of a front axle half according to the invention;

FIG. 3 illustrates a schematic rear view of a front axle half according to the invention; and

FIG. 4 illustrates, in top view, a variant of a front axle half according to the invention.

### DETAILED DESCRIPTION

The different figures represent the right front axle half of a vehicle referenced in space by the reference frame X Y Z.

Since the front axle is symmetric relative to the longitudinal axis X′ of the vehicle, only the right front axle half is represented and described.

The vehicle is symbolized by its longitudinal axis X′ and its vertical axis Z′ which is perpendicular to the longitudinal axis X′ and to the plane of the ground S on which the vehicle runs.

In the different figures, the same references are used to indicate the same elements.

The different drawings are not made to scale.

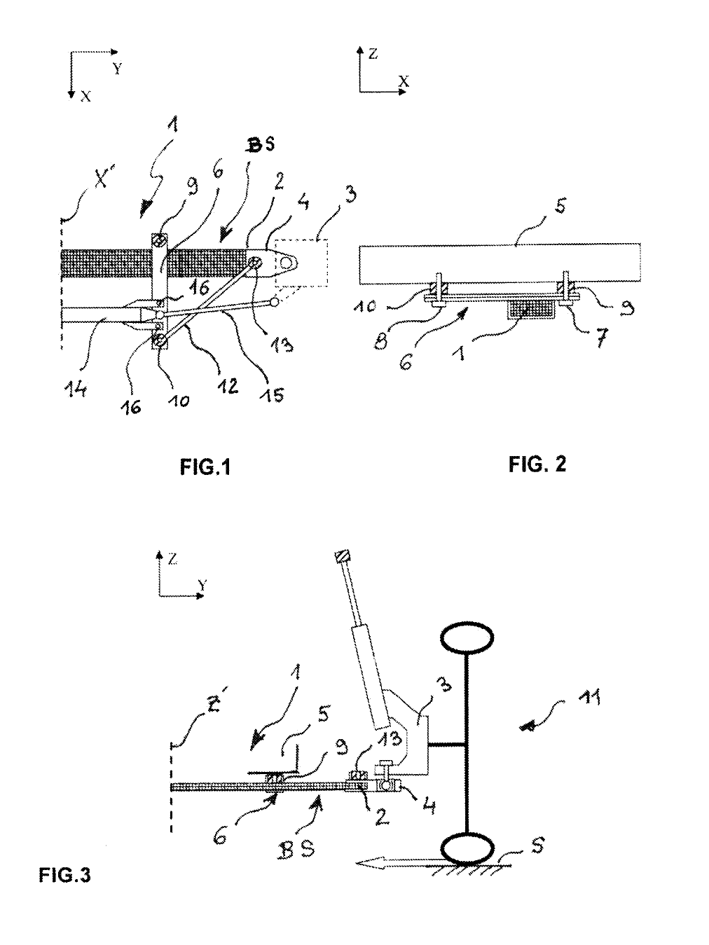

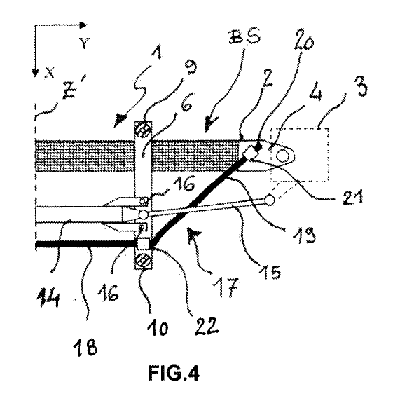

Finally, in FIGS. 1 and 4, the body of the vehicle is intentionally not shown for purposes of clarity.

The front axle comprises a transverse leaf 1 made preferably from a composite material, and which extends transversely in direction Y relative to the vehicle.

The longitudinal axis of the leaf 1 is centered on the axis of a wheel 11.

The extremity 2 of the leaf 1 is linked to a wheel knuckle 3 through the intermediary of a knuckle support 4 which solidly sandwiches the extremity 2 of the leaf 1.

The leaf 1 is suspended under the body 5 of the vehicle (FIG. 2) through the intermediary of a support 6. The support is arranged between the extremity 2 of the leaf 1 and the longitudinal axis X′ of the vehicle and extends transversely relative to the leaf 1 in a direction parallel to the longitudinal axis X′ of the vehicle.

The support 6, for instance, is comprised of two straight bars of rectangular section which are assembled together. One of the bars is flat and the other is bent in such manner as to fit tightly around the leaf 1 in a sandwich mode.

The support 6 is attached to the vehicle body 5 by means of first and second fasteners 7 and 8, for instance bolts, which are located respectively in the two extremities of the support 6. First and second elastic joints 9 and 10, which form spacers and through which the fastening means are inserted, are interposed between support 6 and body 5.

The fasteners 7 and 8 and the joints 9 and 10 are aligned in the longitudinal direction X and the first fastener 7 and the second joint 9 are adjacent to the transverse leaf 1.

The extremity BS of the leaf 1, suspended under body 5 in this manner, extends beyond the body 5 and forms a suspension arm cantilevered relative to body 5 (FIG. 3).

During the displacement of the wheels 11 in the (vertical) direction Z, the leaf 1 deforms according to the principle of a flexing beam supported under body 5 via the two joints 9 and 10.

Since the thickness of leaf 1 is small relative to its width and length, the spring function is ensured by the leaf 1 for symmetric vertical displacement of wheels 11 relative to the longitudinal axis X′ (pumping action).

During asymmetric vertical displacements of wheels 11 (rolling situation), the leaf 1 connecting the two wheels 11 of the front axle assumes an S shape in the Y direction and ensures the anti-roll function.

The function of taking up longitudinal forces when braking (forces opposing the displacement of the vehicle along the axis X) is ensured by a straight arm 12 which is mounted between the extremity 2 of the leaf 1, on the knuckle support 4, and the support 6 of the leaf 1 (force opposing the displacement of the vehicle along the axis X).

The extremities of the arm 12 are mounted respectively to the knuckle support 4 via an elastic joint 13, and to the second joint 10 of support 6.

Since the front axle according to the invention is not using a cradle, the steering rack 14 is mounted between, and on, the two supports 6 of the leaf 1.

The free extremity of the steering arm 15 is coupled by a known pivoting link to the wheel knuckle 3.

With this kind of architecture, the geometry of the axle assembly can be controlled. In other words, the proper positioning of the steering relative to the leaf, and therefore of the steering relative to the knuckle, is guaranteed.

An attachment means 16 for mounting the rack 14 to the support 6 is located in the proximity of the second joint 10.

As illustrated more in particular in FIG. 3, the leaf 1 “takes up” the transverse forces imposed at the base of the wheel 11 during turns. In this way, the leaf ensures good rigidity of the plane of the wheel 11 facing transverse forces symbolized by arrow F; while the arm 12 “takes up” the longitudinal forces when braking. In this way, the leaf 1 works in bending in the vertical direction Z during the displacements of the wheel 11 and in traction / compression during turns. The leaf 1 does not work in bending in the longitudinal direction during braking.

The size of the leaf 1 can be reduced, which reduces the cost, a reduction which is even more important in the case of a leaf 1 made of composite material. This reduces the total cost of the architecture relative to previous solutions.

Leaf 1 is preferably made of glass fiber/epoxy resin composite material in order to allow for sufficient vertical displacement of the wheel 11 without damaging the material. On the other hand, the orientation of the fibers can be transverse in order to increase the characteristics in this direction.

FIG. 4 illustrates a second embodiment of the front axle in which the means for taking up the longitudinal forces during braking, which was comprised of arms 12 in the first embodiment, is replaced by an anti-roll bar 17.

In the fashion of an integral Mac-Pherson type front axle architecture, it is the anti-roll bar 17 which, in this variant, “takes up” the longitudinal forces.

The straight part 18 of the anti-roll bar 17 extends parallel to the transverse leaf 1.

The anti-roll bar 17 ends in each of the extremities of the straight portion with an angled bar 19 which extends at an angle of 45° towards the front of the vehicle.

The extremity 20 of the angled bar 19 is attached to the knuckle support 4 by means of an elastic mount 21, for instance, a rubber joint, and the straight portion 18 of the anti-roll bar 17, located just before the angled part 19, is attached to the support 6, in the proximity of the second joint 10, by an elastic swivel link 22, for instance, a rubber bearing.

This variant eliminates a constraint in the dimensioning of the leaf 1 which no longer ensures by itself the anti-roll bar function of the axle.

With the front axle according to the invention, the extremity BS of the leaf 1, the support 6 and the force take-up means 12 or 17 define respectively the three sides of the suspension arm.

1. A front axle of a vehicle having a body and directional wheels, the front axle supporting each of the directional wheels of the vehicle through the intermediary of a wheel knuckle support, said axle comprising a suspension comprising a transverse leaf formed of composite material attached to the body of the vehicle, said transverse leaf having opposed extremity ends which are solidly connected to the wheel knuckle support, wherein each extremity end of the transverse lee is suspended under the body of the vehicle by a support which sandwiches the extremity end of the transverse leaf, wherein a means for taking up the longitudinal forces when braking is arranged between the support of the transverse leaf and wherein the wheel knuckle support; the extremity end of the transverse leaf, the support and the means for taking up forces in combination define three sides, respectively, of a suspension arm.

2. The front axle according to claim 1, wherein the support is located on the transverse leaf and extends transversely relative to the transverse leaf in a direction parallel to a longitudinal axis (X′) of the vehicle; first and second fastening means are located respectively at the two extremities of the support through the intermediary of first and second elastic joints to mount the support to body of the vehicle; while the first joint is adjacent to the transverse leaf.

3. The front axle according to claim 2, characterized in that the means for taking up longitudinal forces when braking of comprises a straight arm, the one end of which is attached to the knuckle support via an elastic joint, and a second end of which is attached to a second joint of the support.

4. The front axle according to claim 2, wherein the means for taking up longitudinal forces when braking comprises an angled portion of an anti-roll bar extending parallel to the transverse leaf; an extremity of the angled portion of the anti-roll bar is bineg attached to the wheel knuckle support by means of an elastic mount and an extremity of the straight portion of the anti-roll bar being attached to support, in the proximity of the second joint, by means of an elastic pivoting link.

5. The front axle according to any of claim 2, wherein the support of the transverse leaf is also used as a support for a the steering rack of the vehicle; wherein means for mounting the steering rack on the support are arranged in the proximity of the second joint of support.

6. The front axle according to claim 1, wherein each support is arranged between the extremity of the transverse leaf and the longitudinal axis (X′) of the vehicle.

7. The front axle according to claim 1, wherein the longitudinal axis of the transverse leaf (1) is centered on the axis of the wheels.

8. An automotive vehicle comprising a front axle according to claim 1.
